(19) United States
(12) Patent Application Publication
(10) Pub. No.: US 2013/0188357 A1
(43) Pub. Date: Jul. 25, 2013

(54) CHANNEL LETTER LIGHTING SYSTEM USING HIGH OUTPUT WHITE LIGHT EMITTING DIODES

(71) Applicant: THE SLOAN COMPANY, INC. DBA SLOANLED, VENTURA, CA (US)

(72) Inventors: THOMAS C. SLOAN, SANTA BARBARA, CA (US); BRUCE QUAAL, VENTURA, CA (US); TIMOTHY DREW FERRIE, OJAI, CA (US); AARON MEYER, VENTURA, CA (US)

(73) Assignee: THE SLOAN COMPANY, INC. DBA SLOANLED, VENTURA, CA (US)

(21) Appl. No.: 13/791,510

(22) Filed: Mar. 8, 2013

Related U.S. Application Data
(63) Continuation-in-part of application No. 12/316,411, filed on Dec. 12, 2008.

(51) Int. Cl. F21V 21/00

(52) U.S. Cl. CPC F21V 21/00
USPC 362/249.01

(57) ABSTRACT

A channel letter lighting system comprising a plurality of lighting units that are interconnected by a conductor. Each of the units is coupled to the conductor such that an electrical signal applied to the conductor causes the lighting units to emit light. The length of the conductor between said units is adjustable to vary the distance between adjacent ones of the lighting units. In other embodiment the lighting units comprise a plurality of emitters. A conductor is included for carrying an electrical signal with the lighting units connected to and interconnected by a conductor. An electrical signal applied to the conductor causes the emitters emit light.

### RELATED APPLICATIONS

This application is a continuation in part application of Ser. No. 12/316,411 to Thomas Sloan et al., filed on Dec. 12, 2008. The contents of Ser. No. 12/316,411, including the drawings, schematics, diagrams and written description, are hereby incorporated in their entirety by reference.

### BACKGROUND OF THE INVENTION

1. Field of the Invention

This invention relates to lighting units using light emitting diodes (LEDs), and more particularly to LED based interconnected lighting units for different illumination applications such as illuminating channel letters.

2. Description of the Related Art

Recent developments in LEDs have resulted in devices that are brighter, more efficient and more reliable. LEDs are rugged, consume less power, have a relatively long life (up to 100,000 hours), operate at low voltage, and are 30 to 70% more energy efficient than conventional lights, such as incandescent, neon or fluorescent bulbs. As a result of these developments, LEDs are becoming utilized in many more lighting applications that were previously the realm of incandescent, neon or fluorescent light sources.

Channel letters are commonly found on the outside of buildings and are often used to advertise the name of the business. They are typically constructed of aluminum or plastic housing having the shape of a letter and are approximately 5″ deep. The housing has a generally U-shaped cross-section, with the top opening in the housing covered by a colored translucent lens that transmits light from within the housing.

Channel letters are typically illuminated with neon or fluorescent light sources that are mounted within the channel letter housing. Neon and fluorescent lights provide a bright and continuous light source that allows the channel letters to be visible at night. These light sources, however, have a relatively short life (20,000 hours), are fragile, operate at high voltage (7,000 to 15,000 volts for neon) and can consume a relatively large amount of power. Neon bulbs can also experience difficulty with cold starting, which can lead to the bulb's failure.

LEDs are more frequently being used as the light source in different sign applications. U.S. Pat. No. 5,697,175, to Schwartz, discloses a low power illuminated sign that is particularly adapted for use with common EXIT signs over doorways. The back of each sign comprises a reflector with a series of cavities with curved surfaces. Each cavity corresponds to a letter and background area in the sign. LEDs are mounted in the center of the cavities to illuminate the letters or background area. The LEDs are provided on a separate perpendicular circuit board or on a central projection formed in the bottom of the cavities, with light from the LEDS directed outward. The letters and background area of the sign are illuminated by light reflecting forward from the curved surfaces of the cavities, so that the only visible light is from the illumination of the cavities.

U.S. Pat. No. 6,042,248, to Hannah et al., discloses an LED assembly for channel letter illuminating signs having an enclosure/housing covered by a translucent lens. Each sign includes a plurality of track moldings at the base of its enclosure, with the moldings running along the longitudinal axis of the sections of the channel letter. Linear arrays of LEDs are mounted on printed circuit boards (PCBs) that are then mounted in the track moldings. Each track molding can hold two PCBs in parallel with each of the PCBs arranged on a longitudinal edge, with the LEDs directed outward.

LED based channel letter lighting is also available from LumiLEDs, Inc., under part numbers HLCR-KR-R0100 and HLCR-KR99-R0200, which comprises LEDs that are each mounted by insulation displacement connectors (IDC) on two inch centers. The chain of LED modules is then mounted into a bendable clip or rail, each of which is then mounted inside a channel letter to hold the LEDs in place. Power is provided by a combination of an AC/DC mother power supply and a DC/DC daughter power supply. A sensing LED is also included as a temperature and current sensor.

U.S. Pat. Nos. 6,932,495 and 7,241,031, both to Sloan et al. and both assigned to SloanLED, Inc., disclose channel letter lighting units and lighting systems utilizing the lighting units. In some embodiments these lighting units can be provided as multiple lighting units interconnected by conductors in a chain so that an electrical signal applied to the chain causes the lighting units to emit light. The chain can be made available to purchasers on different holding devices such as a box, reel or rack. Different lengths of the chain can be utilized for a particular channel letter, with the desired length of chain being cut from the holding device and mounted within the channel letter. Power can then be applied to the chain in the channel letter causing the units to emit light.

Different types of chains can have different numbers of lighting units per a length, or stated differently, a different density of lighting units. These chains are typically sold at a cost per measure of length, and the cost per length is typically greater for lighting systems having higher density. To accommodate the different needs of customers for chains of different densities, many different types of lighting system chains need to be maintained and stored and made available to customers. In some channel letter applications it may be desirable to have different densities of units in different locations. This can require purchasing multiple chains with different densities for the same job.

Each of the lighting units in the chain also has a certain number of LEDs, such as two, four, eight, sixteen, etc., depending on the embodiment. In certain circumstances it may be desirable to have fewer than all the number of LEDs provided on the units, such as in locations where the illumination should be spread. Conventional lighting units, however, offer little flexibility in reducing the number of LEDs in certain ones or all of the LED units in a chain.

### SUMMARY OF THE INVENTION

The present invention comprises lighting units and systems that can be used to illuminate structures such as illumination of channel letters. One embodiment of a lighting system according to the present invention comprises a plurality of lighting units interconnected by a conductor. Each of the units is coupled to the conductor such that an electrical signal applied to the conductor causes the lighting units to emit light. The length of the conductor between said units is adjustable to vary the distance between adjacent ones of the lighting units.

Another embodiment of a lighting system according to the present invention comprises a plurality of lighting units, each of which further comprises a plurality of emitters. A conductor is included for carrying an electrical signal with the lighting units connected to and interconnected by a conductor. An electrical signal is applied to the conductor which causes the emitters to emit light. The lighting units are separable into sections each of which comprise at least one of the plurality of emitters and each of which remains connected to the conductor. The length of the conductor between the sections is adjustable to vary the distance between adjacent ones of the sections.

Another embodiment of a lighting system according to the present invention comprises a plurality of lighting units connected to and interconnected by a conductor. Each of the lighting units comprises a housing and a printed circuit board (PCB) mounted to the housing. The PCT has having a plurality of light emitting elements arranged so that an electrical signal applied to conductor causes the light emitting elements to emit light substantially away from the housing. A plurality of additional conductor sections is included, each of which is associated with a respective one of the lighting units to increase the length of the conductor between adjacent ones of the lighting units.

Still another embodiment of a lighting system according to the present invention comprises a plurality of lighting units connected to and interconnected by a conductor. Each of the lighting units comprises a printed circuit board (PCB) mounted within a housing, wherein the PCB has a plurality of light emitting elements. A plurality of first additional conductor sections is included, each of which is associated with and extendable from a respective one of the lighting units to increase the length of the conductor between adjacent ones of said lighting units. A plurality of second additional conductor sections is also included wherein at least some of the lighting units are separable into lighting units sections. Each of the lighting unit sections comprises at least one emitter that emits light in response to the electrical signal. At least some of said separable sections have one of the second additional conductors sections that is extendable from the lighting unit section.

In yet another embodiment of a lighting system according to the invention comprises a plurality of lighting units connected to and interconnected by a conductor. Each of the lighting units comprises a printed circuit board (PCB) within a housing, wherein the PCB has a plurality of light emitting elements. At least one additional conductor section, external to the housing, is included between each of adjacent lighting units and is arranged to provide an increased length of conductor, such that each of the additional conductor sections are adapted to increase the distance between adjacent lighting units.

These and other further features and advantages of the invention will be apparent to those skilled in the art from the following detailed description, taken together with the accompanying drawings, in which:

### BRIEF DESCRIPTION OF THE DRAWINGS

FIG. 1 is a perspective view of one embodiment of a interconnect LED lighting unit system according to the present invention;

FIG. 2 is a top view of the lighting unit system shown in FIG. 1;

FIG. 3 is an end view of one of the lighting units in the lighting system shown in FIG. 1;

FIG. 4 is a bottom view of one embodiment of a lighting unit according to the present invention with the housing bottom removed;

FIG. 5 is a bottom exploded view of the lighting unit shown in FIG. 4;

FIG. 6 is a bottom view of another embodiment of a lighting unit according to the present invention with the housing bottom removed;

FIG. 7 is an exploded view of the lighting unit shown in FIG. 6;

FIG. 8 is a top view of another embodiment of a lighting unit according to the present;

FIG. 9 is a top view of another embodiment of a lighting unit according to the present;

FIG. 10 is a top view of another embodiment of a lighting unit according to the present;

FIG. 11 is a top view of another embodiment of a lighting unit according to the present;

FIG. 12 is a bottom view of one embodiment of a interconnect LED lighting unit system according to the present invention with dividable lighting units;

FIG. 13 is a bottom view of the lighting system in FIG. 12 with the lighting units separated;

FIG. 14 is a bottom view of the light unit system in FIG. 12 with lighting units divided;

FIG. 15 is a bottom view of a lighting unit according to the present invention with a perforation divider;

FIG. 16 is a bottom view of a lighting unit according to the present invention with a tab divider;

FIG. 17 is a bottom view of a lighting unit according to the present invention with two tab divider;

FIG. 18a is a side view of another embodiment of a lighting unit according to the invention;

FIG. 18b is a side view of another embodiment of a lighting unit according to the invention; and

FIG. 18c is a side view of another embodiment of a lighting unit according to the invention.

### DETAILED DESCRIPTION OF THE INVENTION

The present invention provides a lighting system that can be used in many different applications such as structural lighting, display lighting and ingress/egress lighting, but is particularly applicable to channel letter lighting. The systems according to the present invention provide lighting units that are interconnected in a chain by electrical conductors so that an electrical signal applied to the input end of the conductors spreads to the lighting units, causing them to emit light. According to the present invention, the conductors between the LED units can have an adjustable length to allow for the length of conductors to be altered in the, which allows for the density of the LED units to be customized to meet the particular application. For example, in channel letter applications there may be instances where chains or sections of chains having different densities are desired, and the present invention allows for the density to be altered in the field to meet these different needs.

Other embodiments of the present invention can provide other means for adjusting the density of emitters along the chain of lighting units, and in some embodiments these adjustments can be made in the field. In different embodiments, the number of light sources can be spread along the chain by separating, detaching or breaking apart the lighting units into multiple lighting units, with each of the separated light units having at least one of the light sources from the original unit. The lighting system can also comprise a length of conductor between the separated sections of the lighting units to spread the separated portions of the lighting units. These embodiments not only allow for the number of light sources to be divided between the separated lighting units sections, but also allow for the density to be reduced by having a conductor between the separated units.

The present invention is described herein with reference to certain embodiments but it is understood that the invention can be embodied in many different forms and should not be construed as limited to the embodiments set forth herein. In particular, the invention is described with reference to certain embodiments where the length of a conductor can be increased between adjacent lighting units or lighting unit sections, but in other embodiments the length of the conductor can be decreased. In these embodiments, the decreased conductor length increases the density of lighting units and/or light emitter. Further, many different mechanism and arrangements can be used to allow for the density of lighting units or light sources to be adjusted along the length of the chain of lighting units. The present invention can also be used with different types of lighting units used in different applications beyond channel letter lighting, and although the present invention is described herein with reference to light emitting diodes (LED or LEDs) other light sources can be used.

It is also understood that when an element such as a layer, region or substrate is referred to as being “on” another element, it can be directly on the other element or intervening elements may also be present. Furthermore, relative terms such as “inner”, “outer”, “upper”, “above”, “lower”, “beneath”, and “below”, and similar terms, may be used herein to describe a relationship of one layer or another region. It is understood that these terms are intended to encompass different orientations of the device in addition to the orientation depicted in the figures.

Although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Embodiments of the invention are described herein with reference to illustrations that are schematic illustrations of embodiments of the invention. As such, the actual thickness of the layers and features can be different, and variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. A region illustrated or described as square or rectangular will typically have rounded or curved features due to normal manufacturing tolerances. Thus, the regions illustrated in the figures are schematic in nature and their shapes are not intended to illustrate the precise shape of a feature of a device and are not intended to limit the scope of the invention.

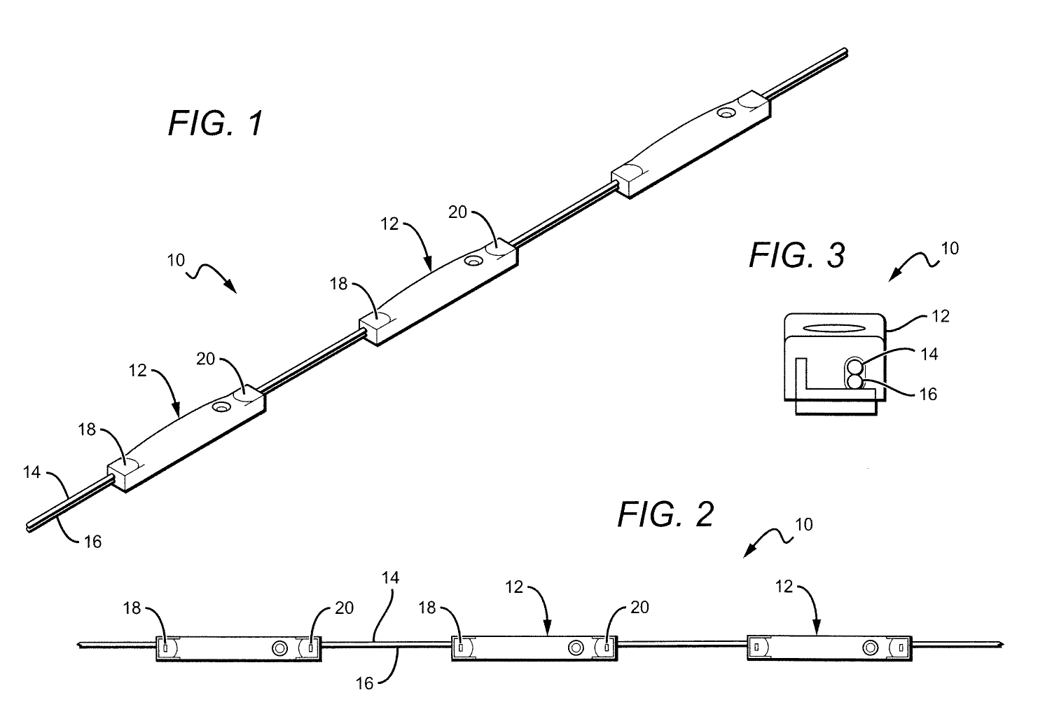

FIGS. 1 through 3 show one embodiment of a lighting system 10 according to the present invention that comprises a number of lighting units 12 daisy-chained together by first and second electrical conductors 14, 16. Each of the lighting units 12 has first and second light elements 18, 20 (described below) that illuminate out from the unit 12 in response to an electrical signal. The electrical conductors 14, 16 conduct electricity to the units 12 and an electrical signal applied to the conductors 14, 16 at one end of the lighting system 10 is conducted to each of the units 12 so that the light elements 18, 20 on each of the units 12 simultaneously emit light. The units 12 are particularly adapted to being mounted in channel letters, each of which has a transparent or translucent cover. With a translucent cover, when the light elements 18, 20 are illuminated in the channel letters, the light is diffused to give the appearance that the channel letters have a continuous light source.

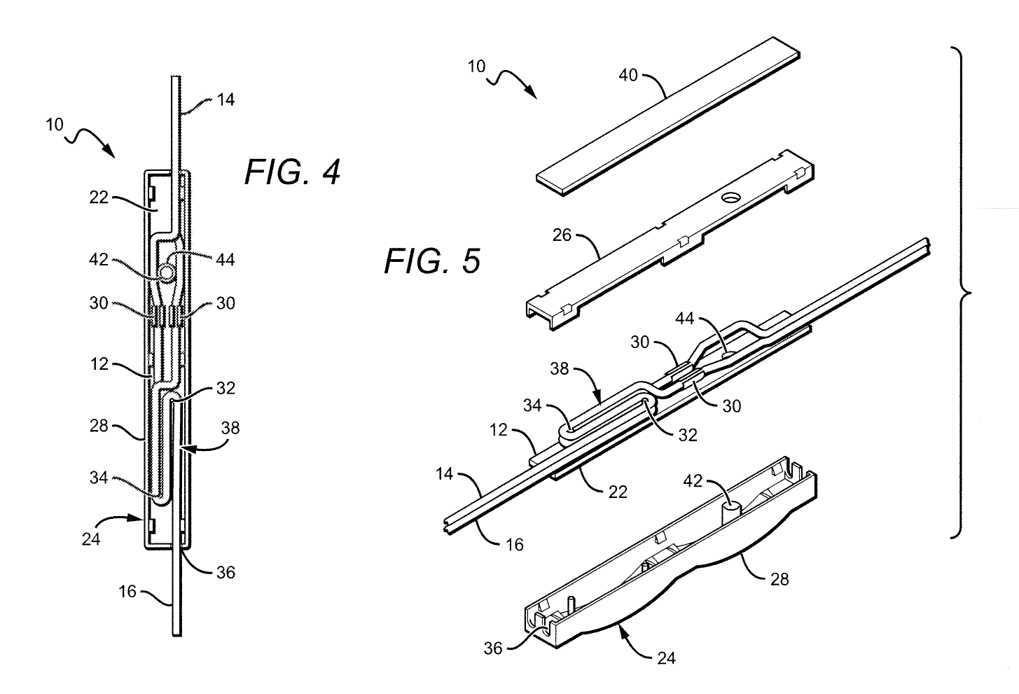

FIGS. 4 and 5 show the lighting system 10 in FIGS. 1 through 3 in more detail, with the lighting units 12 and conductors 14, 16 shown from different angles. Each of the units comprises a printed circuit board (PCB) 22 mounted within a lighting unit housing 24. The housing 24 comprises a bottom housing portion 26 and a top housing portion 28 that can be mounted together with the PCB 22 held between the two. The housing 24 can be made of many conductive, semi-conductive and non-conductive materials, with a preferred material being plastic and can be made using many known processes such as by extrusion or injection molding. In the embodiment shown, the top and bottom portions 26, 28 snap together with the PCB 22 between the two.

The PCB 22 has first and second lighting elements 18, (shown in FIG. 1) mounted to one side, and conductor connectors 30 mounted on the other side for connecting the PCB to the conductors 14, 16. Many different connectors can be used, with a suitable connector being an insulation displacement connector (IDC). The IDC connectors 30 can be arranged to allow the conductors 14, 16 to run down the lighting units with each of the IDC connectors 30 electrically coupling the signal on the conductors 14, 16 to its respective one of the units 12, without interrupting the signal traveling down the conductors 14, 16. This arrangement allows for the units 12 to be daisy-chained along the conductors 14, 16 without the conductors 14, 16 being interrupted. The PCB 22 also comprises conductive traces (not shown) to conduct electrical signals from the connectors 30 to the lighting elements 18, 20 so that an electrical signal applied to the first and second conductors 14, 16 is conducted to the lighting elements 18, 20 through the connectors 30 and traces, causing the elements to emit light.

The elements 18, 20 are generally mounted along the longitudinal axis of the PCB 22, although they can also be mounted in other locations. In other embodiments the lighting units can comprise more than two lighting elements, such as four, six, and eight or more, that can be mounted in many different locations. The light elements 18, 20 can be any device that emits light in response to an electrical signal, such as incandescent lights, lasers, laser diodes, fluorescent light or neon lights, with the preferred light elements 18, 20 being light emitting diodes (LEDs). The elements 18, 20 can emit different colors of different intensities, with a suitable LED being commercially available emitting high luminous flux white light.

The PCB 22 can be any conventional type made from any conventional material, with a preferred PCB 22 being a metal core type PCB. Different types of metal core boards can be used such as an aluminum core board. By being a metal core, heat from the light elements conducts into the PCB 22 so that the PCB 22 helps draw away heat from the light elements 18, 20. The PCB 22 then provides a larger surface that allows the heat to dissipate into the surrounding ambient. This can help keep the light elements 18, 20 cooler, which can allow them to operate under a higher current so that they can emit a higher luminous flux.

Lighting units according to the present invention can also comprise other elements, with one embodiment comprising constant current devices that can be mounted on the PCB using conventional methods. This allows each of the units to have substantially the same current driving its light elements 18, 20 so that each of the units 12 emits substantially the same amount of light. The light elements 18, 20, and constant current device can be interconnected by conductive traces on the PCB using conventional methods. Without a constant current device, the system 10 can experience light loss as the power signal passes down the conductors 14, 16 through each of the units 12. This can ultimately result in a channel letter exhibiting different brightness across its cover or by different channel letters in a sign having different brightness. By driving each of the light elements 18, 20 in each of the units 12 with the same current, the light elements along the conductor will have the same brightness. Many different constant current devices can be used, with a suitable device being an LM317M 3-Terminal Adjustable Regulator provided by Texas Instruments, National Semiconductor, and Fairchild Semiconductor.

The PCB 22 can also comprise first and second break-away pins 32, 34 which as shown are included on the bottom of the PCB 22. The pins 32, 34 can be formed using many different methods, such as the pins being bonded or molded to the PCB 22 using known methods. The pins 32, 34 can be mounted in many different locations to the PCB 22 or the housing 24 and can comprise many different shapes and sizes. For pins 32, 34 located on the PCB, it is understood the size and location of the pins 32, 34 should be such that they do not interfere with the housing 24. The pins 32, 34 are also sized and positioned so that and additional section 38 of the conductors 14, 16 can be held within the housing 24, with the conductors 14, 16 wrapping around the pins 32, 34 in a serpentine manner. In the embodiment shown, the conductors enter the housing 24 and wrap around the first pin 32. The conductors 14, 16 continue toward and around the second pin 34 and then back to the connectors 30.

This arrangement of the pins 32, 34 and conductors 14, 16 arrangement provides the additional length or section 38 of conductor 14, 16 within the housing 24 that can be used to increase the length of the conductors 14, 16 between the units 12. This in turn can decrease the density of lighting units per length of the system 10, and can be accomplished in the field without having to disassemble the light units 12. To increase the length of conductors 14, 16 a pulling force can be applied to the conductors 14, 16 on the end of the units having the pins 32, 34. When a sufficient force is reached, the pins 32, 34 can break-away from the PCB 22. This frees the wrapped additional section 38 to unwrap from the pins 32, 34 so that it can be pulled out of the housing opening 36. This results in an increase in the length of conductors 14, 16 between the unit 12 with particular unit with the pins broken-away and the unit 12 adjacent to it.

Each lighting unit 12 can be mounted within a channel letter by many different methods such as by glue, clamp, bolt, weld, etc. As shown, the housing 24 can be provided with double sided tape 40 on its bottom surface for mounting. Many different double sided tapes can be used, with a preferred tape being a commercially available double sided foam tape provided by 3M Corporation. The housing 24 can also be provided with an alternative mounting method that can be used alone or in conjunction with the double sided tape 40. The housing includes a housing mounting hole 42 through which a screw, nail or rivet can pass to mount the housing 24. The PCB 22 also comprises a PCB mounting hole 44 in alignment with the housing mounting hole 42. In one embodiment according to the present invention a screw can pass through the PCB mounting hole 44 and into the housing mounting hole 42. A screwdriver can then pass through the PCB mounting hole 44 to turn the screw into the channel letter, through the housing mounting hole 42.

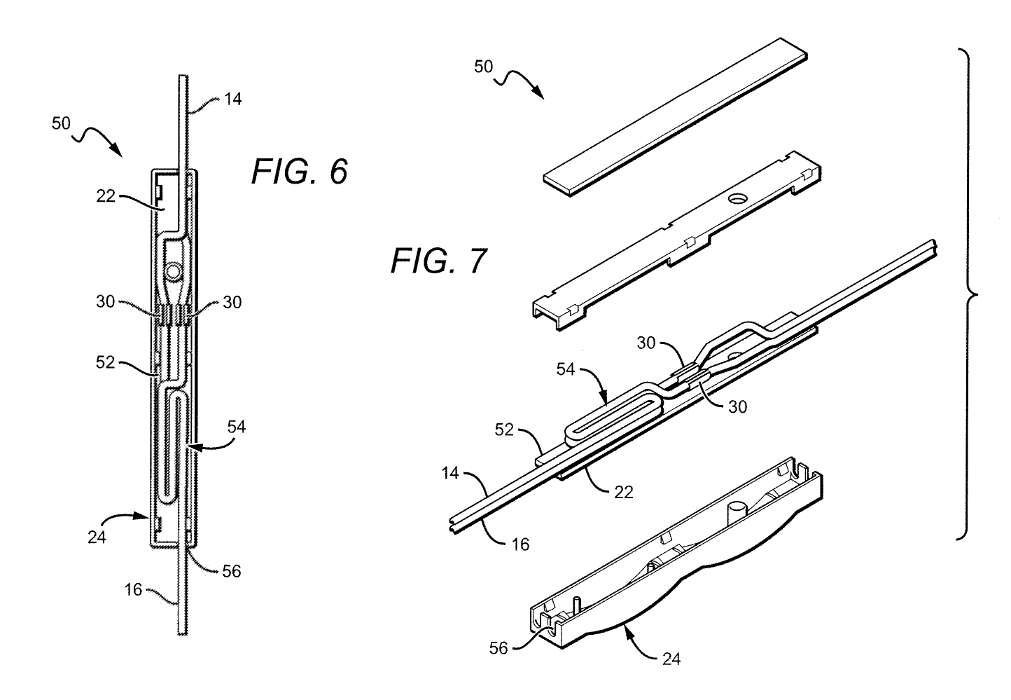

FIGS. 6 and 7 show another embodiment of a lighting system 50 according to the present invention comprising lighting units 52 having many of the same features and light units 12 shown in FIGS. 1-5 and described above. For the same or similar features the same reference numbers will be used herein with the understanding that the description above applies to this embodiment, as well as the embodiments described below.

The units 52 comprise a housing 24 with a PCB 22 mounted within the housing 24. The PCB 22 holds two light emitters (not shown) on one side and connectors 30 on the other. Conductors 14, 16 enter the housing 24 and are electrically connected to the PCB by connectors 30 as described above. In this embodiment, an additional section 54 of the conductors 14, 16 is held in the housing 24 in a coiled or serpentine manner, although it is understood that the conductors 14, 16 can be arranged in many different ways. In this embodiment, the housing's first conductive opening 56 is sized to closely fit around the conductors 14, 16. The close fit causes the opening 56 to pinch around the outside of the conductors 14, 16 to hold the conductors in place within the opening 56. To expand lengthen the conductors 14, 16 between adjacent ones of the units 52, a pulling force is applied to the conductors 14, 16 sufficient to overcome the pinching force. This allows for the section 54 to be pulled out of the housing 24, effectively increasing the length between the adjacent ones of the units 52. It is noted that for this and other embodiments, all or part of the conductor section 54 to be pulled from the housing to provide flexibility in the length between adjacent units 52.

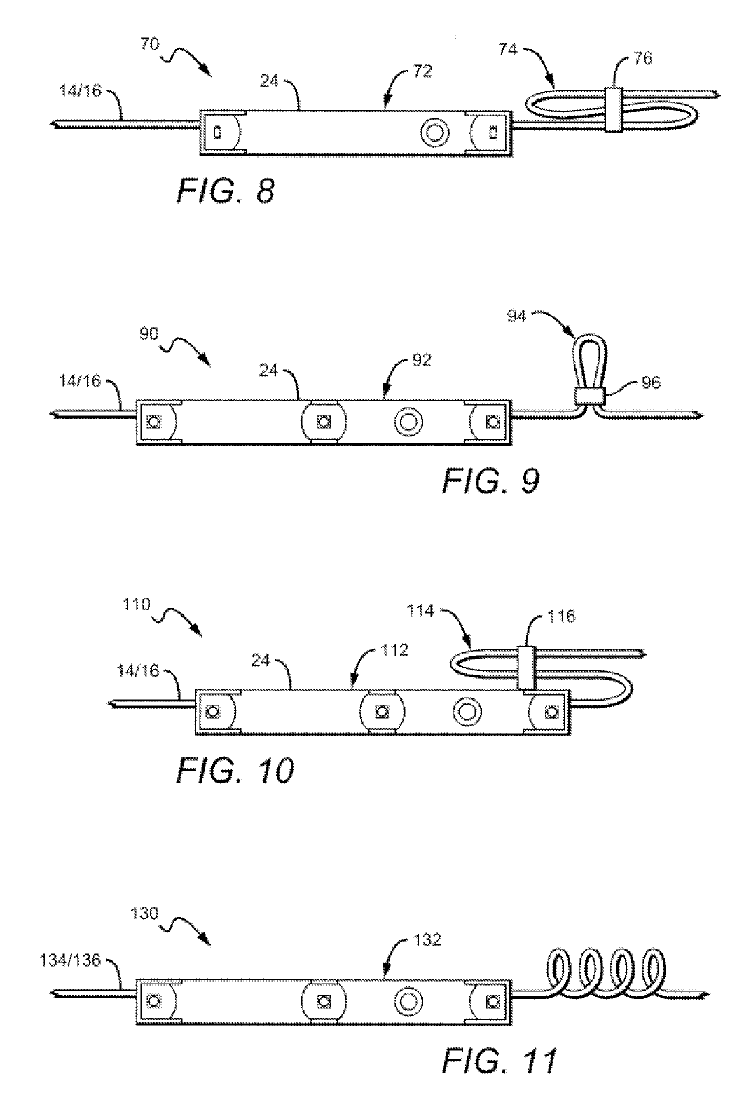

In other embodiments, a section of the conductors can be arranged in many different ways to allow for increasing length of conductors between adjacent units. FIG. 8 shows another embodiment of a lighting system 70 comprising lighting units 72 interconnected by conductors 14, 16. Although only one lighting unit 72 is shown in FIG. 8 (and FIGS. 9-11), it is understood that multiple lighting units can be provided in a chain as described above. An additional section 74 of the conductors 14, 16 is provided for increasing conductor length between adjacent units, but in this embodiment the section is not held within the housing 24. Instead, it is held outside the housing 24 in a serpentine manner and held together by a holding device 76, such as but not limited to a clip, clamp or bracket, which is affixed to the conductors 14, 16. In one embodiment, the holding device 76 can be overmolded on the conductors 14, 16 using known molding processes.

The holding device 76 can be arranged in many different configurations and is not intended to be limited to being a clip, clamp, bracket or an overmold. In other embodiments, the holding device 76 can be glue, epoxy, or hot melt placed around the conductors 14, 16 to hold the conductors 14, 16 in a serpentine manner. In other embodiments, the holding device 76 can be in the form of a shrink tube or shrink wrap that is placed around the conductors 14, 16 and then heated to shrink around and/or conform to the shape of the conductors 14, 16 in order to hold the conductors 14, 16 in a serpentine manner. In other embodiments the holding device 76 can be in the form of a casing, collar, staples, crimps that are placed around the conductors 14, 16 and arranged to hold the conductors 14, 16 in a serpentine manner. In yet another embodiment, the holding device 76 can be in the form of labels, tape, paper, string, rubber bands, zip ties, or hook and loop fastener that are wrapped around the conductors 14, 16 to hold the conductors 14, 16 in a serpentine manner. In yet other embodiments, more than one holding device 76 can be used to hold the conductors 14, 16 in a serpentine manner, wherein any of the holding devices described herein can be used or a combination thereof. Furthermore, the holding device 76 can be made of many different types of material, such as but not limited to, plastic, metal, paper, wood, and the like, or a combination thereof.

To increase the length between adjacent units 72, a pulling force is applied to the conductors 14, 16 sufficient to overcome the holding force between the conductors 14, 16 and the holding device 76. This results in the section 74 being released from the holding device 76 increasing the length between the adjacent units 72. In different embodiments the force can release all or part of the section 74 from the holding device 76 allowing for different additional lengths of conductors 14, 16. This provides flexibility in the different lengths between adjacent units 72, and flexibility in lighting unit density.

An advantage of the invention is that the holding device 76 allows the spacing between adjacent units 72 to be varied, which provides flexibility in varying the distance between adjacent units for any lighting solution. Yet another advantage of adjusting the spacing between adjacent units 72 is the ability to modify the light distribution of adjacent units and/or all the units 72 utilized for the given lighting solution. This allows the lighting units 72 to be customizable so that they can be used in many different lighting solutions and/or settings. This also allows the light emission radiation pattern of adjacent units 72 or of all the units to be modified or adjusted to suit any lighting solution.

The ability to customize the invention allows the invention to be used as a universal lighting system for many different lighting applications, which reduces the need to purchase and/or fabricate specialized lighting systems for different lighting applications. For example, the ability to increase the spacing between two adjacent lighting units can allow the lighting system to bend around corners of a channel letter or other enclosures to be illuminated and maintain the appearance of a constant light source. In another example, the ability to increase the spacing between two adjacent lighting units also allows the radiation pattern of the emitted light from the lighting units to be altered for any given lighting solution, i.e. adjust spacing to reduce hot spots or improve distribution of emitted light to reduce dark spots.

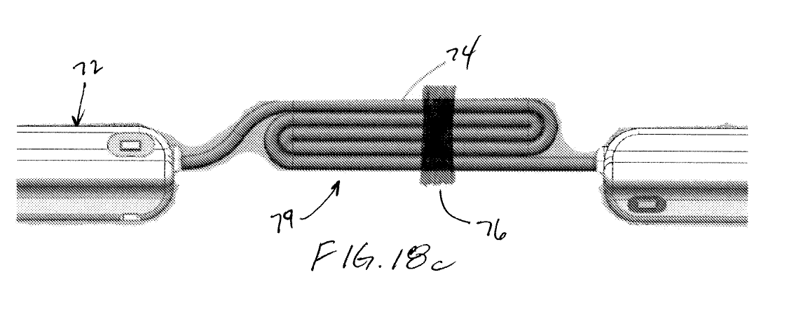

In the embodiment of the invention shown in FIG. 8, the additional section 74 of the conductors 14, 16 is shown to be arranged in a serpentine configuration. However, the additional section 74 can be arranged in many different serpentine configurations and is not intended to be limited to the embodiment shown in FIG. 8. In other embodiments, as shown in FIG. 18a, the additional section 74 is arranged in a serpentine configuration 77 along the entire spacing between adjacent units 72. This allows the spacing between adjacent units 72 to be increased by a factor of the original spacing between the adjacent units 72. For example, in FIG. 18a, upon the application of a pulling force on either of the adjacent units 72 and releasing the additional section 74 of conductors 14, 16 from the holding device 76, the spacing between the adjacent units 72 can be increased by a factor of approximately three times the original spacing. This is due to the additional section 74 of the conductors 14, 16 arranged in a serpentine configuration 77 along the entire spacing between adjacent units 72.

The increased spacing between adjacent units 72 can be many different lengths and can be determined by the serpentine configuration of the additional section 74 of the conductors 14, 16. FIG. 18b shows another embodiment of the invention showing a different serpentine configuration between adjacent units 72, wherein the additional section 74 is arranged to comprise a plurality of serpentine configurations 77. The embodiment of the invention shown in FIG. 18b discloses two serpentine configurations 77, but the invention is not intended to be limited to only two serpentine configurations; other embodiments can be arranged such that the additional section 74 can have more than two serpentine configurations. Each of the serpentine configurations 77 can comprise one or more holding devices 76 holding the conductors 14, 16 in the serpentine configuration 77.

An advantage of the embodiment of the invention of FIG. 18b is that part of the additional section 74 of the conductors 14, 16 can be released from the holding device 76. For example, one of the serpentine configurations 77 can be released from the holding device 76 by pulling the adjacent unit 72 and/or the respective conductors 14, 16, thereby increasing the spacing between adjacent units 72 by only the conductors 14, 16 within the respective serpentine configuration 77, while the conductors 14, 16 in the other serpentine configuration 77 remains intact in the serpentine configuration 77. An advantage of the invention is that the spacing between adjacent units 72 can be incrementally increased by freeing the conductors 14, 16 in the serpentine configuration 77. Incrementally increasing the spacing between adjacent units 72 allows the spacing between adjacent units 72 to be adjusted in a smaller amount than having to release the entire additional amount 74 of conductors 14, 16 between adjacent units. This provides greater flexibility in adjusting the spacing between adjacent units 72 as well as the light distribution of adjacent units 72.

In yet another embodiment of the invention, the additional section 74 of the conductors 14, 16 between adjacent units 72 can be arranged in a spiral-like configuration 79 wherein an extended length of conductors 14, 16 can be disposed between the adjacent units 72. The spiral-like configuration 79 is retained by the holding device 76 and is arranged to provide an extended length of conductors 14, 16 greater than that of the embodiments of FIGS. 8 and 18a-b.

FIG. 9 shows another embodiment of a lighting system 90 according to the present invention comprising lighting units 92 interconnected by conductors 14, 16. This embodiment also has an additional conductor section 94 outside of the housing 24, with the section 94 held by a holding device 96 that is similar to the holding device 76 shown in FIG. 8. In this embodiment, however, the holding device 96 holds the section 94 in a loop instead of in a serpentine manner. To increase the length between adjacent units 92, a pulling force is applied to the conductors 14, 16 sufficient to pull the conductors 14, 16 from the holding device 96. This in turn increases the length of the conductors 14, 16 between adjacent units 92, with all or part of the section 94 being pulled from the holding device 96.

FIG. 10 shows still another embodiment of a lighting system 110 comprising lighting units 112 interconnected by conductors 14, 16. This embodiment also has an additional section 114 of conductors 14, 16 arranged outside of the lighting unit 112, with the section 114 also held by a holding device 116 that is similarly configured to the holding device 76 shown in FIG. 8. In this embodiment, however, the lighting unit 112 comprises the holding device 116 such that the additional section 114 is received and held by the lighting unit 112. The holding device 116 holds the additional section 114 adjacent the housing 24. In some embodiments the holding device 116 can be on an external surface of the housing 24, while in other embodiments the holding device 116 can be within the housing 24. The holding device 116 can be molded as part of the lighting unit 112, with the conductors 14, 16 then molded or bonded with in the holding device 116. Alternatively, the holding device 116 can be molded over the conductors 14, 16, with the holding device then molded or bonded to the lighting unit 112. The holding device 116 can be molded or bonded to any part of the lighting unit 112, such as but not limited to the housing 24. In other embodiments, the holding device 116 can be adapted to be detachable from the housing 24. For example, the holding device 116 can be detached by an application of force or by using a sharp instrument to cut or score the holding device 116 to allow the holding device 116 to be separated from the housing 24. In some embodiments, detaching the holding device 116 from the housing 24 frees the additional section 114 from being held by the holding device 116. In other embodiments, the holding device 116 maintains the additional section 114 within the holding device 116 after being detached from the housing 24, such that the additional section 114 can be released from the holding device 116 at a later time. To increase the length of the conductors 14, 16 between adjacent units 112 a pulling force can be applied to the conductors 14, 16 to overcome the holding force of the holding device 116. This additional section 114 can be fully or partially pulled from the holding device 116. An advantage of the invention is that the spacing between adjacent lighting units 112 can be increased incrementally by at least the amount of additional section 114 released from the holding device 116 and/or by detaching the holding device 116 from the housing 24. This provides flexibility in varying the spacing between adjacent lighting units 112 for various lighting solutions.

The additional section 114 can also be arranged in a serpentine configuration 77 similarly as shown in FIGS. 18a-c. However, instead of the serpentine configuration being in the space between adjacent lighting units, the serpentine configuration is disposed adjacent the lighting unit 112, for embodiments wherein the lighting unit 112 comprises the holding device 116. The spacing between adjacent lighting units 112 is adjustable in proportion to the amount of conductor in the serpentine configuration.

In other embodiments, different types of conductors can be provided between adjacent units to allow for different conductor length. FIG. 11 shows another embodiment of a lighting system 130 according to the present invention having lighting units 132 interconnected by first and second conductors 134, 136. In this embodiment, the conductors are of the coil type, similar to those used on to connect a phone receiver to a phone. With no pulling force applied to the conductors 134, 136, the conductors remain coiled and at their shortest length. When a pulling force is applied to the conductors 134, 136, the loops in the conductors 134, 136 uncoil, increasing the length of the conductors 134, 136. The increase in length is commensurate with the level of pulling force applied to the conductors 134, 136. The coiled conductors 134, 136 are biased toward the coiled condition when the pulling force is removed the conductors return to their coiled condition. A force can be needed to hold the conductors 134, 136 at the desired increased length and uncoiled condition. A sufficient holding force can be provided by the mounting force for the lighting units. That is, the holding force of the lighting unit mounting tape and/or mounting screws can be sufficient to hold the increased length of the conductors 134, 136 against the recoil force of the conductors.

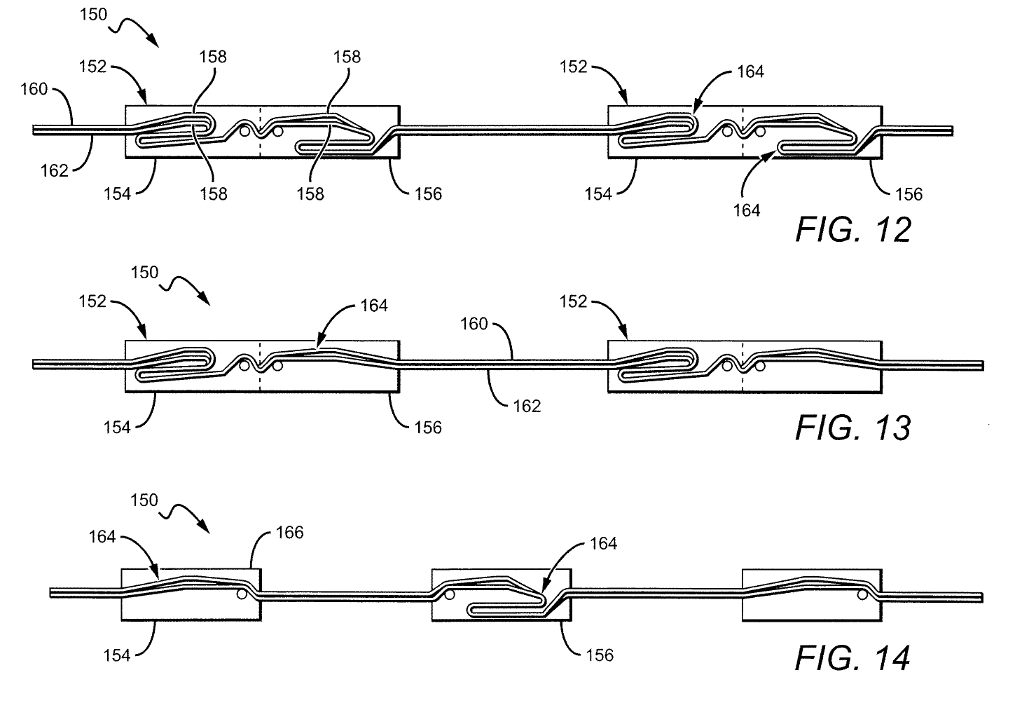

Lighting systems according to the present invention can be arranged in many different ways to allow for reducing the density of lighting units or lighting elements in a chain of lighting units. In the embodiments described above, the density can be decreased by increasing the length of conductor between different ones of the lighting units. FIGS. 12 through 14 show a lighting system 150 comprising interconnected lighting units PCBs 152 arranged so that the density of lighting elements and lighting units can be varied by varying the length between adjacent modules and/or by separating the lighting elements on the units. It is understood that the PCBs 152 can be arranged in lighting units housings as described above but for ease of description and understanding are shown without their housing. It is further understood that the description below regarding separating of the PCBs also contemplates separation of the housing holding the PCBs.

Referring to FIG. 12, the PCBs 152 are shown prior to any manipulation to decrease density. Each of the PCBs 152 has first and second sections 154, 156 that are approximately equal in size and joined at a middle score, perforation or break. Each of the sections 154, 156 has two connectors 158, each of which electrically connects one of the first and second conductors 160, 162 to the PCB 152. Each of the sections 154, 156 can also have an additional conductor section 164 of first and second conductors 160, 162 arranged in a serpentine manner. These additional conductor sections 164 allow for the lighting units 152 to be further separated as described above, and as further described below, allow for the lighting units to be separated by separating or dividing lighting elements on the lighting units. The lighting system 150 can have many different sized PCBs that can be separated in many different ways and lengths, and the PCBs can comprise many different numbers of light emitters.

Referring now to FIG. 13, the PCBs 152 are shown after the length of conductors 160, 162 between adjacent PCBs 152 is increased to decrease unit density. This can be accomplished by pulling and extending the additional conductor 164 associated with the second section 156, as described above. This can provide additional conductor length between the PCBs 152. The PCBs can be further separated by extending the additional conductor 164 associated with the first PCB section 154.

Alternatively, as shown in FIG. 14 the first and second sections 154, 156 of the lighting units 152 can be separated, detached or broken apart along the break or dividing line 166. The additional conductor 164 associated with the first section 154 and be extended to allow separation between the first and second sections 154, 156. To allow further separation between the sections 154, 156, the additional conductor 164 associated with the second section 156 can also be extended.

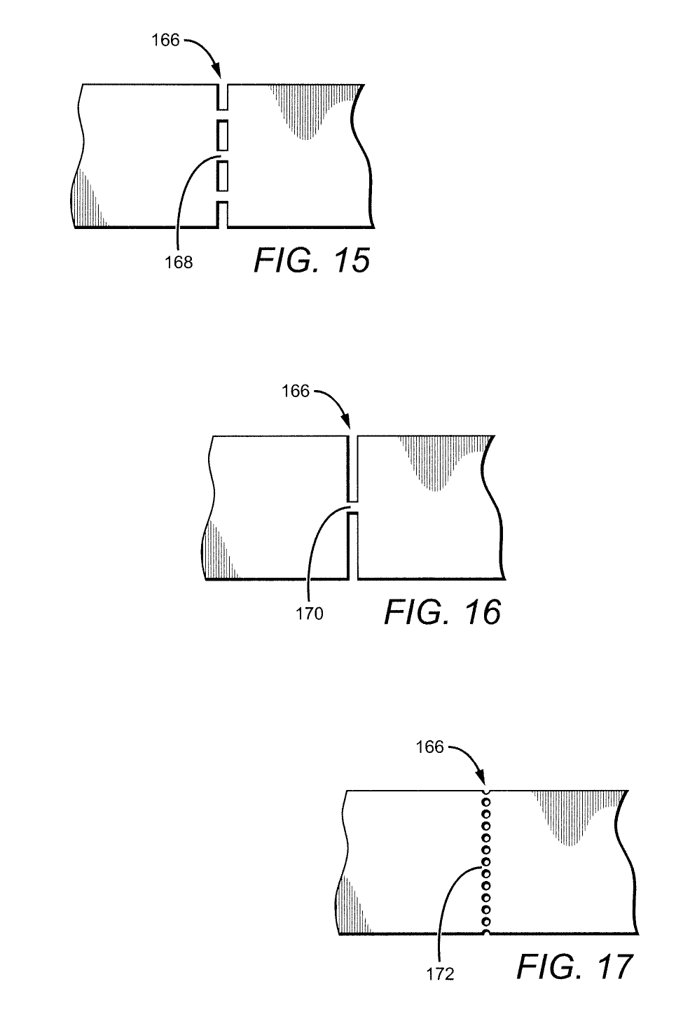

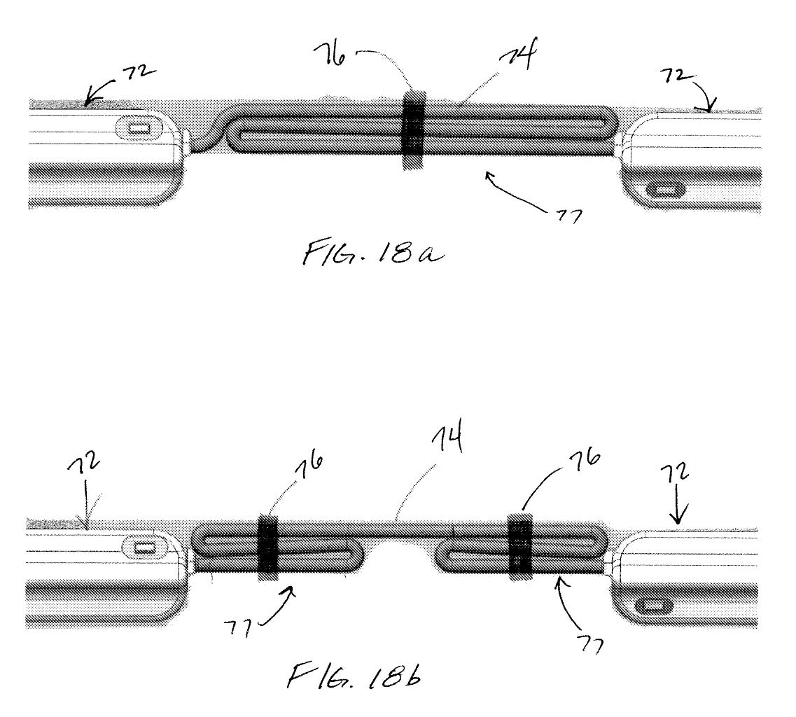

The PCBs can be have different break or dividing lines 166 that facilitate separation or breaking apart of the PCBs into different sections. FIG. 15 shows one embodiment of a dividing line 166 comprising three tabs 168 that allow the section to be separated by manually breaking the tabs. FIG. 16 shows another embodiment of a dividing line 166 comprising a single tab 170 that can also be manually broken. FIG. 17 shows still another embodiment of a dividing line 166 comprising a perforation 172 that can also be manually broken. It is understood that the dividing line can be arranged in many different ways and can comprise many different features. The housings holding the PCBs can also have break lines in alignment of the PCB break lines facilitate breaking apart of the overall lighting units. Alternatively, means can be employed to separate the lighting units such as sawing or etching, but care should be taken not to damage the conductors.

It is further understood that different applications of different combinations of PCB (lighting unit) separation and PCB (lighting unit) detachment can be utilized to achieve the desired lighting density for the lighting system. For example, two adjacent PCBs can be separated by extending the additional conductor, while adjacent PCBs can be detached or broken apart. These variations can continue down the LCB or lighting unit chain.

Although the present invention has been described in considerable detail with reference to certain preferred configurations thereof, other versions are possible. Lighting units according to the invention can be used for many different applications beyond channel letters. A separate power supply can be used for each channel letter or multiple letters can be powered by a single power supply. In other embodiments, a variable power supply can be used to control the intensity of the light emitters. The lighting unit can be many different sizes and can be used in many different applications beyond channel letters. The PCB can have different numbers of LEDs and can have different electronic components arranged in different ways. The conductors can be different lengths and instead of running uninterrupted between the units, the conductors can have connectors. This would allow the units to be supplied separately and then connected together when installed. Therefore, the spirit and scope of the invention and should not be limited to the preferred versions described above.

We claim:

1. A lighting system, comprising:
a plurality of lighting units interconnected by a conductor, each of said lighting units coupled to said conductor and adapted to emit light in response to an electrical signal applied to said conductor;
a spacing separating adjacent lighting units of said plurality of lighting units comprised of an additional section of said conductor, wherein at least part of said additional section of said conductor is adapted to extend said spacing between adjacent lighting units; and
at least one holding device arranged to hold at least part of said additional section of said conductor and to maintain said spacing between adjacent lighting units.

2. The lighting system of claim 1, wherein at least one of said plurality of lighting units comprises said at least one holding device, wherein said at least part of said additional section is received by said at least one of said plurality of lighting units.

3. The lighting system of claim 2, wherein said at least one holding device is removably coupled to said at least one of said plurality of lighting units.

4. The lighting system of claim 3, wherein said spacing between adjacent lighting units arranged to increase by at least partially removing said at least one holding device from said lighting unit.

5. The lighting system of claim 3, wherein said spacing between adjacent lighting units arranged to increase by at least partially removing said at least one holding device from said at least part of said additional portion.

6. The lighting system of claim 1, wherein said at least one holding device is on said additional section of said conductor between adjacent lighting units.

7. The lighting system of claim 1, wherein each of said lighting units comprises a housing, a printed circuit board (PCB) within said housing, and at least one light emitting element on said PCB, said at least one light emitting element adapted to emit light in response to said electrical signal.

8. The lighting system of claim 7, wherein said housing further comprising a mounting mechanism to mount each of said plurality of lighting units to a structure.

9. The lighting system of claim 1, wherein said spacing between adjacent lighting units arranged to increase by at least partially removing said at least one holding device from said at least part of said additional section.

10. The lighting system of claim 1, wherein at least part of said additional section of said conductor is arranged in a serpentine configuration.

11. The lighting system of claim 10, wherein said spacing is extended at least by the amount of said conductor arranged in said serpentine configuration.

12. The lighting system of claim 10, wherein said serpentine configuration extends along at least part of said spacing between adjacent lighting units.

13. The lighting system of claim 10, wherein said serpentine configuration extends along substantially all of said spacing between adjacent lighting units.

14. The lighting system of claim 10, wherein said additional section of said conductor is arranged to comprise a plurality of serpentine configurations between adjacent lighting units, wherein said spacing can be incrementally increased by at least partially removing said at least one holding device from at least one of said plurality of serpentine configurations.

15. The lighting system of claim 1, wherein said holding device is wrapped around said additional portion of said conductor.

16. The lighting system of claim 1, wherein said holding device is formed around said additional portion of said conductor.

17. The lighting system of claim 1, wherein said holding device is disposed around said additional portion of said conductor.

18. The lighting system of claim 17, wherein said holding device is treated to conform around said additional portion of said conductor.

19. A lighting system, comprising:
an array of lighting units connected to and interconnected by a conductor, wherein each of said lighting units comprises:
a housing;
a printed circuit board (PCB) within said housing and having at least one light emitting element, wherein said at least one light emitting element adapted to emit light substantially away from said housing; and
a plurality of additional section of said conductor between adjacent lighting units of said array and arranged to provide a space between said adjacent lighting units of said array, wherein at least part of each of said plurality of additional sections adapted to increase said space between said adjacent lighting units; and
at least one holding device configured to receive at least part of a respective one of said plurality of additional sections and to maintain said space between said adjacent lighting units.

20. The lighting system of claim 19, wherein said housing comprises said at least one holding device such that at least part of said respective one of said plurality of additional section is received and held by said housing.

21. The lighting system of claim 20, wherein said at least one holding device is within said housing.

22. The lighting system of claim 20, wherein said at least one holding device is disposed on an external surface of said housing.

23. The lighting system of claim 19, wherein each of said lighting units further comprises a mounting mechanism for mounting each of said lighting units to a structure.

24. The lighting system of claim 19, wherein said space between adjacent lighting units is arranged to increase by at least partially removing said at least one holding device from at least part of said respective one of said plurality of additional sections.

25. The lighting system of claim 19, wherein at least one of said plurality of additional sections is arranged in at least one serpentine configuration, wherein said at least one holding device receives at least part of said at least one serpentine configuration.

26. The lighting system of claim 25, wherein said space is arranged to be increased by the amount of said conductor arranged in said at least one serpentine configuration.
